(19) United States
(12) Patent Application Publication
(10) Pub. No.: US 2024/0230123 A1
(43) Pub. Date: Jul. 11, 2024

(54) AIR PURIFIER FOR PETS THAT COMBINES AND SEPARATES THE DUST COLLECTOR MODULE

(71) Applicant: PEPE INC., Hanam-si (KR)

(72) Inventors: Geon Ho SHIN, Hanam-si (KR); Wan Il SO, Paju-si (KR)

(73) Assignee: PEPE INC., Hanam-si (KR)

(21) Appl. No.: 18/104,202

(22) Filed: Jan. 31, 2023

(30) Foreign Application Priority Data
Jan. 11, 2023 (KR) 10-2023-0004176

(51) Int. Cl. F24F 8/80; A01K 13/00; F24F 8/95; F24F 13/078; F24F 13/08; F24F 13/20

(52) U.S. Cl. CPC F24F 8/80; A01K 13/001; F24F 8/95; F24F 13/078; F24F 13/085; F24F 13/20; F24F 13/28

(57) ABSTRACT

The present invention relates to an air purifier for pets that combines and separates a dust collector module, and more particularly, to an air purifier for pets that combines and separates a dust collector module, including an air purifying module that sucks in and purifies surrounding air, and discharges the air to the outside, and a dust collector module in which one side is seated on, and coupled to or separated from an upper portion of the air purifying module to suck in at least one of air and hairs of a pet through one side.

### TECHNICAL FIELD

The present invention relates to an air purifier for pets that combines and separates a dust collector module, and more particularly, to an air purifier for pets that combines and separates a dust collector module to make it easy to care for the pet by separating a dust collector module combined to an upper portion of an air purifying module and brushing hairs of the pets or drying the hairs after bathing.

### BACKGROUND ART

An air purifier refers to a device that performs a purification action such as suctioning indoor contaminated air, and then removing contaminated substances in the suctioned air, and discharges purified air.

The air purifier may select an air purifying function or automatically perform the air purifying function according to a control by a user or a degree of the contaminated substances distributed in the suctioned air.

In particular, in the case of a home or pet cafes in which the pets live, hairs, dust, and contaminated substances of the pets are further present in addition to general contaminated substances, and there is a possibility that bacteria will be propagated due to the hairs, dust, and contaminated substances of the pets, so stronger air purification is required.

Meanwhile, as the related art, Korean Patent Registration No. 10-1828936 (registered on Feb. 7, 2018) titled “an air purifier and a control method thereof” provides a configuration in which fans provided in a plurality of air purifying modules or a circulation fan provided in a flow control device is selectively driven based on a operation mode or a contamination level sensed by a sensor device to determine an air volume discharged from the air purifier.

However, in the case of the home or pet cafes in which the pets live, since hairs, dust, and contaminated substances of animals are locally rapidly increased with activities of the pets, there is a limit in rapidly removing the hairs, dust, and contaminated substances.

### PRIOR ART DOCUMENT

### Patent Document

(Patent Document 001) Korean Patent Registration No. 10-1828936 (registered on Feb. 7, 2018)

### DISCLOSURE

### Technical Problem

To solve the above problems in the related art, the present invention provides an air purifier for pets that combines and separates a dust collector module, which can make it easy to care for pets by separating a dust collector module combined to an upper portion of an air purifying module and brushing hairs of the pets or drying the hairs after bathing.

Further, the present invention provides an air purifier for pets that combines and separates a dust collector module, which reduces a pressure of air by collecting air introduced the inside and the outside of one side of an inner case in the other side of an outer case by actuating a suction fan unit to increase a suction force of suctioning external air.

Further, the present invention provides an air purifier for pets that combines and separates a dust collector module, in which a dust collector module guides air discharged from an air purifying module that is seated on an upper portion of the air purifying module by a dust collector module's own weight, and sucks in and purifies hairs scattered in a home and surrounding air to a long distance.

### Technical Solution

In order to solve the above problems, the present invention provides an air purifier for pets that combines and separates a dust collector module, which includes: an air purifying module that sucks in and purifies surrounding air, and discharges the air to the outside; and a dust collector module in which one side is seated on, and coupled to or separated from an upper portion of the air purifying module to suck in at least one of air and hairs of a pet through one side.

In addition, the air purifying module may further include a base body part which has one or more suction ports at a lower portion, and one or more different types of filters therein.

In addition, the dust collector module may further include a body part having an inner case into which air discharged from the air purifying module is introduced and an outer case which surrounds a front surface and a rear surface of the inner case, and discharges the air moved through the inner case to the outside, a suction grill unit coupled to one side of the outer case, and formed by a suction grill in which one surface has an inclination surface which is convex toward the inner case, and a suction fan unit having a motor fan at one side of the inner case.

In addition, the suction grill unit may further include a guide unit that has each wall body on the inclination surface of the suction grill to guide the air.

In addition, the suction grill unit may further include an air movement unit which is formed by a case coupled to be in communication with the suction fan unit, and has a plurality of wall body protrusions arranged on one or more outer surfaces of the case.

In addition, the dust collector module may further include a dust collection filter unit that is disposed between the suction grill and the air movement unit, and collects the hairs of the pet introduced into the suction grill unit when locating the pet at one side of the inner case.

In addition, the dust collector module may further include an air movement pipe that surrounds the suction fan unit and extends toward the other side of the inner case, and moves the air discharged from the air rotation unit to the other side of the outer case.

In addition, the dust collector module may have a movement guide unit that is arranged in plural one at least one side of a front surface and a rear surface of the inner case, and moves the air discharged from the suction grill unit to the other side of the outer case.

In addition, the dust collector module may collect the air discharged from the air movement pipe and the air moved from the movement guide unit into the other side of the outer case to generate a pressure difference of the air.

In addition, the air purifier for pets that combines and separates a dust collector module may include a cover unit having a cover body that opens/closes the other side of the dust collector module and at least one discharge grill unit on each of both sides of one surface of the cover body.

In addition, air purifier for pets that combines and separates a dust collector module may include an illumination unit including an infrared lamp which is accommodated inside the other side of the dust collector module and emits light.

In addition, air purifier for pets that combines and separates a dust collector module includes a 3-axis sensor unit capable of sensing different functions according to coupling or separating the dust collector module to or from the air purifying module inside the outer case.

### Advantageous Effects

According to the present invention, an air purifier for pets that combines and separates a dust collector module, which can reduce cost for caring for the pets and easily care for the pets by separating a dust collector module coupled to an upper portion of an air purifying module and brushing hairs of the pets or drying the hairs after bathing.

Further, there is an advantage in that an infrared lamp is provided in the other side of a body part to prevent dermatonosis, arthritis, and tympanitis of the pets with air discharged through a discharge grill unit and an infrared lamp, thereby reducing medical expenses.

Further, there is an advantage in that a pressure of air is reduced by collecting air introduced the inside and the outside of one side of an inner case into the other side of an outer case by actuating a suction fan unit to increase a suction force of sucking in external air.

Further, there is an advantage in that a dust collector module guides air discharged from an air purifying module that is seated on an upper portion of the air purifying module by a dust collector module's own weight, and sucks in and purifies hairs scattered in a home and surrounding air to a long distance, thereby providing a hygienic and fresh environment.

Further, there is an advantage in that heat generated by actuation of an electric motor is discharged by forming a heat discharge pipe which is in communication with a suction fan unit in the other direction of an inner case to increase a suction force of sucking in air into the suction grill unit due to a temperature difference between air introduced into one side of the inner case and hot air.

### DESCRIPTION OF DRAWINGS

FIG. 1 is a perspective view illustrating an external appearance of an air purifier for pets that combines and separates a dust collector module according to an embodiment of the present invention.

FIG. 2 is a cross-sectional view illustrating a cross section taken along A-A′ of FIG. 1.

FIG. 3 is a perspective view illustrating an air purifying module of an air purifier for pets that combines and separates a dust collector module according to an embodiment of the present invention.

FIG. 4 is an exploded perspective view illustrating disassembly of a dust collector module of the air purifier for pets that combines and separates a dust collector module according to an embodiment of the present invention.

FIG. 5 is an exploded cross-sectional perspective view of FIG. 4.

FIG. 6 is an exemplary diagram illustrating an air movement pipe and an air rotation unit of the air purifier for pets that combines and separates a dust collector module according to an embodiment of the present invention.

FIG. 7 is an exemplary diagram illustrating a state of brushing pets by using the air purifier for pets that combines and separates a dust collector module according to an embodiment of the present invention.

FIG. 8 is an exemplary diagram illustrating a state of caring for the pets by using the air purifier for pets that combines and separates a dust collector module according to an embodiment of the present invention.

### BEST MODE

Hereinafter, a preferred embodiment of the present invention will be described in detail as to be easily implemented by those skilled in the art, with reference to the accompanying drawings. However, in describing an operating principal of the preferred embodiment of the present invention in detail, detailed description related to known function or constitutions will be omitted if it is determined that they may unnecessarily make the gist of the present invention unclear.

Further, the same reference numeral is used for a part which performs a similar function and a similar action throughout the drawings.

Further, throughout the specification, when it is described that a part is “connected” with another part, it not only means that the parts are “directly connected” to each other, but also means that the parts are “indirectly connected” to each other with another element interposed therebetween. Further, unless explicitly described to the contrary, the word “include” and variations such as “includes” or “including” will be understood to imply the inclusion of stated elements but not the exclusion of any other elements.

Hereinafter, an air purifier for pets that combines and separates a dust collector module according to a preferred embodiment of the present invention will be described in detail with reference to the accompanying drawings.

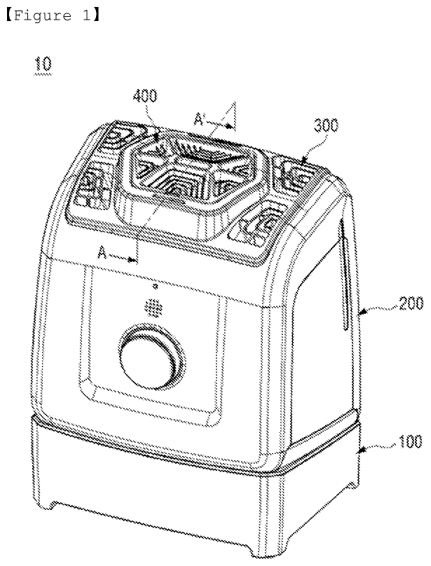

As illustrated in FIG. 1, the air purifier 10 for pets that combines and separates a dust collector module according to an embodiment of the present invention includes an air purifying module 100 and a dust collector module 200.

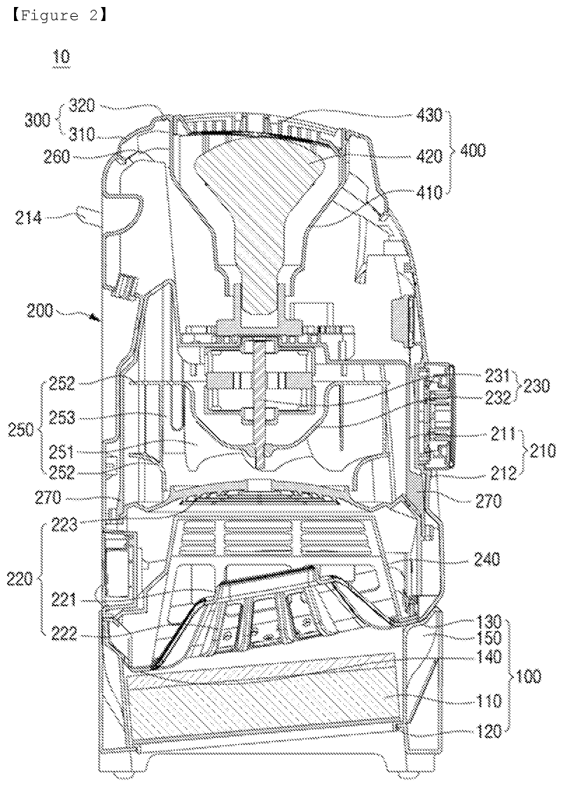

More specifically, as illustrated in FIGS. 1 and 2, the air purifier 10 for pets that combines and separates a dust collector module according to an embodiment of the present invention includes an air purifying module 100 that sucks in and purifies surrounding air, and discharges the air to the outside, and a dust collector module in which one side is seated on, and coupled to or separated from an upper portion of the air purifying module to suck in at least one of the air and hairs of the pets.

“One side” used throughout this specification includes indicating a lower portion spaced from a bottom surface in a vertical direction and facing the bottom surface. In addition, the other side includes indicating the upper portion.

Further, when coupling or fastening of components is generally known, a detailed description thereof is omitted in reference numerals and contents of the specification.

Further, since a control unit or a manipulation means for actuating the present invention includes the generally known component, a detailed description thereof is omitted.

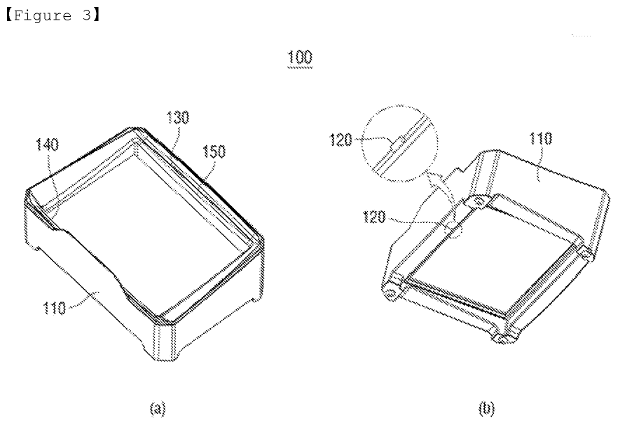

Referring to FIGS. 2 and 3, the air purifying module 100 sucks in the surrounding air, purifies the air through a filter, and discharges the filtered air to the outside.

To this end, the air purifying module 100 further includes a base body part 110, a suction port 120, a first short edge step 130, and a second short edge step 140.

The base body part 110 is formed by a casing which has one or more suctions ports 120 at the lower portion and may have one or more different types of filters mounted therein.

In particular, the base body part 110 is formed with the upper portion to be opened, and has a HEPA filter mounted therein to filter fine dust and discharge the purified air through one side of the dust collector module 200.

Further, the base body part 110 may first have a mesh net filter mounted therein, and then the HEPA filter is mounted on the upper portion of the mesh net filter to further purify the air.

As illustrated in FIG. 3(b), the suction port 120 has a step along a lower circumference of the base body part 110, and a plurality of holes are formed at the step to introduce the external air into the inside of the base body part 110.

In this case, a leg which makes the lower portion of the base body portion 110 be spaced apart from the bottom surface is formed to smoothly introduce the external air.

A first short edge 130 is configured by forming a short edge at the upper portion of a front side of the base body part 110, and allows the front side of one side of the dust collector module 200 to be described below to be seated.

A second short edge 140 has a short edge formed at the upper portion of the front side of the base body part 110, and is formed to have a lower height than the first short edge 130.

This is to differentiate spacing distances between the upper portion of the air purifying module 100, and the front side and the rear side of one side of the inner case 211 as a height of the rear side of one side of the dust collector module 200 to be described below is formed to be higher than the front side.

As a result, when the air discharged from the upper portion of the air purifying module 100 is introduced into one side of the inner case 211, the movement of the air is facilitated by preventing a vertex phenomenon.

Meanwhile, as illustrated in FIGS. 2 and 3, in the air purifier 10 for pets that combines and separates a dust collector module according to an embodiment of the present invention, the air purifying module 100 may further include a light emitting unit 150.

The light emitting unit 150 is formed along an upper end surface of the base body part 110 and even though the dust collector module 200 is seated, light emitting unit 150 emits light therebetween to express a state of the surrounding air with different colors. In addition, the light emitting unit 150 may also be used as an indirect illumination during the night.

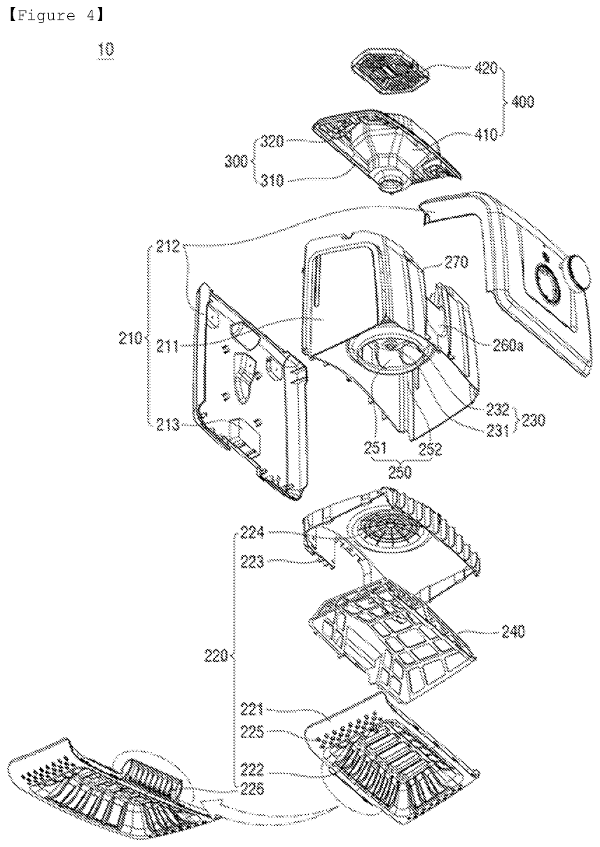

Referring to FIGS. 2 and 4, the dust collector module 200, in which one side is seated on, and coupled to or separated from the upper portion of the air purifying module 100, serves to suck in at least one of the air and the hairs of the pet through one side.

That is, when the dust collector module 200 is seated on the upper portion of the air purifying module 100, the dust collector module 200 sucks in the purified air and collects the air into the other side of the body part 210 to be described below, and then discharges the air to the outside.

Further, the dust collector module 200 is separated from the air purifying module 100, and when the pet is located at one side, the dust collector module 200 sucks in the hairs of the pet and collects the hairs in a dust collection filter unit 240 to be described below, and moves only the air to the other side of the body part 210.

To this end, the dust collector module 200 further includes a body part 210, a suction grill unit 220, and a suction fan unit 230.

The body part 210 has an inner case 211 into which the air discharged from the air purifying module is introduced, and an outer case 212 which surrounds a front surface and a rear surface of the inner case 211, and discharges the air moved through the inner case 211 to the outside.

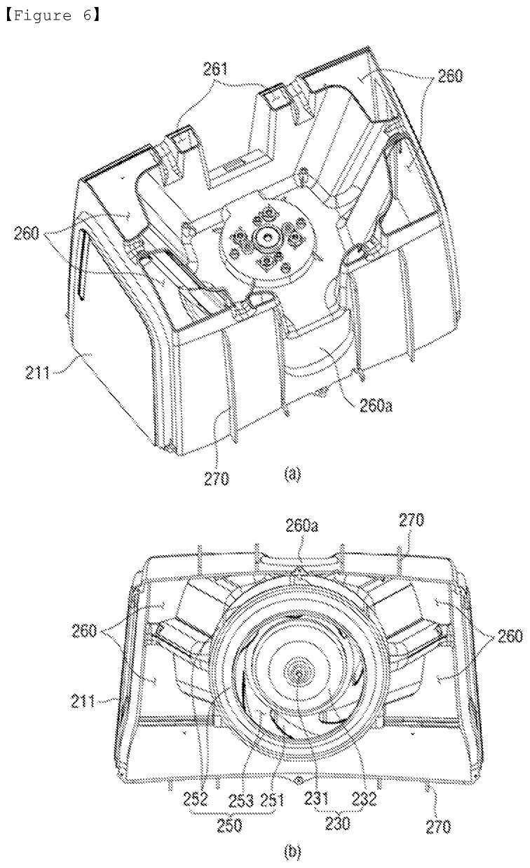

Referring to FIGS. 4 and 6, the inner case 211 is a case into which the air discharged from the air purifying module 100 is introduced.

To this end, a plate of which one portion is opened, and the suction fan unit 230 to be described below is located inside the plate. In addition, an air movement pipe 260 to be described below is extended to the other side of the plate to surround the suction fan unit 230.

Referring to FIGS. 2 and 4, the outer case 212 is formed by a first plate in which an inner surface is coupled to the front surface of the inner case 211 while being spaced apart from the front surface of the inner case 211 by a predetermined distance, and one side of the plate is bent so that the outer case 212 is coupled to the other side of the inner case 211. In addition, the bent portion is opened to couple a cover unit 300 and an illumination unit 400 to be described below.

Further, the outer case 212 is formed by a second plate which is coupled while being spaced apart from the rear surface of the inner case 211 by a predetermined distance.

Here, the outer case 212 is combined while being spaced apart from the front surface and the rear surface of the inner case 211 in order to secure a passage for the movement of the air. A detailed description thereof is made by referring to a movement guide unit 270 to be described below.

Further, a guide protrusion 213 may be further formed at one side of the inner surface of the second plate forming the outer case 212.

The guide protrusion 213 serves to guide the air moving through the suction grill unit 220 to be described below to be introduced into the rear surface of the inner case 211.

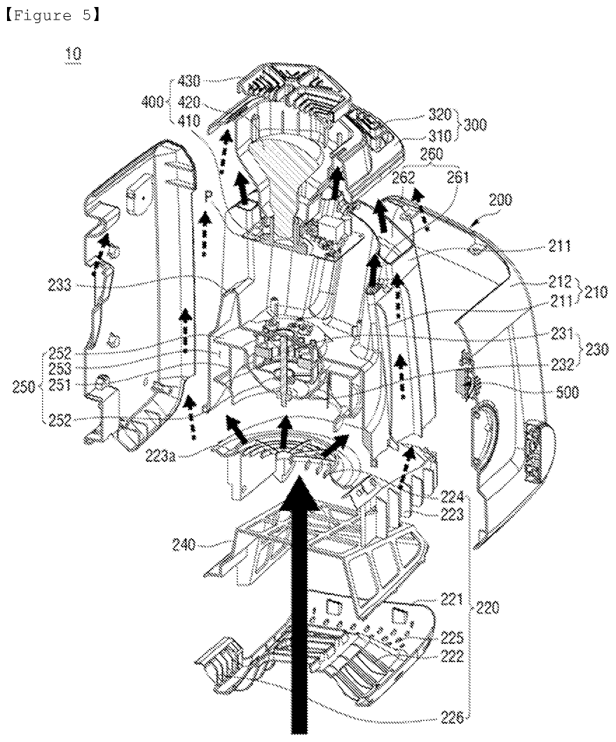

Referring to FIGS. 4 and 5, the suction grill unit 220 is coupled to one side of the outer case 212, and one surface is formed by a suction grill 221 having an inclination surface which is convex toward the inner case 211.

The suction grill 221 allows at least one of external air, the hairs of the pet, and the purified air discharged from the air purifying module 100 to be introduced into one side of the inner case 211.

In particular, since the inclination surface of the suction grill 221 is accommodated in the inside of one side of the inner case 211, the suction grill 221 prevents the introduced air from being leaked to the outside.

As illustrated in FIGS. 4 and 5, the suction grill unit 220 further includes a guide unit 222 and an air movement unit 223.

The guide unit 222 has a wall body which protrudes on the inclination surface of the suction grill 221 to guide the air.

That is, the guide unit 222 moves the air moved toward the suction grill 221 by actuation of the suction fan unit 230 to one side of the inner case 211 more rapidly.

Referring to FIGS. 4 and 5, the air movement unit 223 is formed by a case which is coupled to be in communication with the suction fan unit 230, and has a plurality of wall body protrusions arranged on one or more outer surfaces of the case.

In other words, in the air movement unit 223, one side is formed by a case which is opened to accommodate the inclination surface of the suction grill 221, and the other side forms a communication hole 224 to be in communication with the suction fan unit 230. In addition, the wall body protrusion is formed on at least one outer surface among respective wall bodies forming the case.

Here, as illustrated in FIG. 4, the wall body protrusion is formed on each of outer surfaces corresponding to the front surface and the rear surface of the inner case 211 to move the air to the front surface and the rear surface of the inner case 211.

The communication hole 224 moves the air moved through the suction grill 221 by the actuation of the suction fan unit 230 to the inside of the inner case 211.

In this case, the suction grill unit 220 is formed with the communication hole 224 to protrude toward the suction fan unit 234. In addition, the suction grill unit 220 is spaced apart from a circumference of the communication hole 224 to form the step at the other side of the air movement unit 223 to be in close contact with the air rotation unit 250 to be described below.

As a result, the air discharged through the communication hole 224 is moved to the air rotation unit 250 and rotated to increase a movement speed of the air.

Meanwhile, as illustrated in FIGS. 4 and 5, in the air purifier 10 for pets that combines and separates a dust collector module according to an embodiment of the present invention, the suction grill unit 220 further includes an introduction hole 225 and a discharge hole 226.

With respect to the introduction hole 225, a plurality of holes are formed on both side surfaces of the suction grill 221 to introduce the air into the inner case 211.

This is to guide the flow of the surrounding air to the center by collecting the air introduced into both sides of the suction grill 221 at the center of the suction grill 221.

The discharge hole 226 is formed on a border of the suction grill 221 corresponding to the rear surface of the inner case 221 to serve to guide the flow of the surrounding air to the center of the suction grill 221 by introducing the air into the inclination surface formed on at the center portion of the suction grill 221.

Referring to FIGS. 5 and 6, the suction fan unit 230 is configured by forming a motor fan at one side of the inner case 211, and allows at least one of the external air, the hairs of the pet, and the purified air discharged from the air purifying module 100 to be sucked into one side of the inner case 211.

To this end, the suction fan unit 230 further includes a motor fan shaft 231 and a motor accommodation unit 232.

A motor fan shaft 231 is rotated by the electric motor, and a rotation blade is coupled to one end. Here, the rotation blade which is a general shape is omitted in the drawing in order to clearly discriminate a coupling relationship of the configuration of the present invention.

The motor accommodation unit 232 is formed by accommodating the electric motor at the center of a partition plate that partitions one side and the other side of the inner case 211.

Further, the motor accommodation unit 232 allows the illumination unit 400 to be described below and a board P including an electronic circuit in order to actuate the electric motor to be seated and coupled.

In addition, the suction fan unit 230 may further include a heat discharge pipe 233 that discharges heat generated at the other side of the motor accommodation unit 232 by the actuation of the electric motor to the outside.

In particular, the heat discharge pipe 233 may increase the movement speed of the air introduced into one portion of the inner case 211 due to a temperature difference from the air introduced into one side of the inner case 211.

As illustrated in FIGS. 4 to 7, in the air purifier 10 for pets that combines and separates a dust collector module according to an embodiment of the present invention, the dust collector module 200 may further include a duct collection filter unit 240, an air rotation unit 250, an air movement pipe 260, and a movement guide unit 2670.

Referring to FIGS. 4 and 5, the dust collection filter unit 240 is a filter that is disposed between the suction grill 221 and the air movement unit 223, and collects the hairs of the pet introduced into the suction grill unit 220 at the time of locating the pet at one side of the inner case 211.

In the duct collection filter unit 240, one side is coupled to the suction grill 221, and the other side is formed by a frame having an inclination which converges on the center toward the air movement unit 223, and at least one frame is formed inside the frame to form a space part.

A mesh net is attached to the frame to collect the hairs of the pet and move the air.

As an example, as illustrated in FIG. 7, the dust collector module 200 is separated from the air purifying module 100 and disposed on the bottom surface, and the pet is located at one side of the body part 210 to brush the pet.

In this case, the air and the hairs of the pet scattered to the surrounding are introduced into the suction grill unit 220 by the actuation of the auction fan unit 230, so the air moves to the air rotation unit 250 and the air movement unit 223 by passing through the dust collection filter unit 240. In addition, the hairs of the pet are collected by the dust collection filter unit 240.

Referring to FIGS. 5 and 6, the air rotation unit 250 serves to rotate the air introduced into the inner case 211 by arranging curve type partitions 251 radially around the motor fan.

To this end, the air rotation unit 250 is constituted by a flange extended from the motor accommodation unit 232 and a lower plate spaced apart from the flange, and an introduction pipe 252 penetrated by the center of the lower plate to be in close contact with the communication hole 224 is formed.

In this case, the curve type partition 251 is formed between the flange and the lower plate constituting the introduction pipe 252 to connect the flange and the lower plate to each other.

Further, the introduction pipe 252 moves the air introduced from the communication hole 224 to the curve type partition 251. In addition, the curve type partitions 251 are spaced apart from each other to form the discharge hole 253.

Therefore, by a process in which the air is moved along the curve type partition 251 and discharged through the discharge hole 253, the air is rotated inside one portion of the inner case 211 to increase an introduction speed of the air.

Referring to FIGS. 5 and 6, the air movement pipe 260 is a pipe that surrounds the suction fan unit 230, extends toward the other side of the inner case 211, and moves the air discharged from the air rotation unit 250 to the other side of the outer case 212.

In other words, the air movement pipe 260 extends in the other direction while facing each other based on the suction fan unit 230 and becomes the wall body of the inner case 211. In addition, an empty space is formed inside and becomes a passage for moving the air.

In this case, both short-direction sides of the inner case 211 extend while facing each other, and in a long direction of the inner case 211, the air rotation unit 250 may further have an air discharge hole 260a at one side of the inner case 211 in response to the location.

The air discharge hole 260a discharges some of the air which is introduced into one side of the inner case 211 and rotated to each of outer front and rear surfaces of the inner case 211 and moves the discharged air to the other side of the inner case 211.

This is to increase the discharge speed of the air by using the pressure difference of the air by reducing the pressure of the air collected into the other side of the inner case 211.

Meanwhile, as illustrated in FIG. 6, in the air purifier 10 for pets that combines and separates a dust collector module according to an embodiment of the present invention, the suction grill unit 220 may further include a sub air movement pipe 261.

The sub air movement pipe 261 is formed by a pipe into which some of the air which is introduced into one side of the inner case 211 and rotated by the air rotation unit 250 may be introduced at each one side of the air movement pipe 260.

Referring to FIGS. 5 and 6, the movement guide unit 270 is a partition wall which is arranged in plural one at least one side of the front surface and the rear surface of the inner case 211 and moves the air discharged from the suction grill unit 211 to the other side of the outer case 212.

That is, the movement guide unit 270 serves to guide the air to move to the other side of the inner case 211 when the air introduced into the inclination surface of the suction grill 221 is introduced between the inner case 211 and the outer case 212 by passing through the air movement unit 223.

As such, the dust collector module 200 generates the pressure difference of the air by collecting the air discharged from the air movement pipe 260 and the air moved from the movement guide unit 270 into the other side of the outer case 211.

Therefore, the flow of the additional air to the air moved by the actuation of the suction fan unit 230 is generated to increase a discharge amount of the air to a cover unit 300 to be described below.

Further, the flow of the air is more facilitated by the generation of the pressure difference of the air to move the air discharged to a discharge grill unit 320 formed in the cover unit 300 to the long distance.

As illustrated in FIGS. 4 and 5, the air purifier 10 for pets that combines and separates a dust collector module according to a preferred embodiment of the present invention includes a cover unit 300.

The cover unit 300 has a cover body 310 that opens/closes the other side of the dust collector module 200 and at least one discharge grill unit 320 on at least one of both sides of one surface of the cover body 310.

Here, as illustrated in FIG. 1, the discharge grill unit 320 is disposed at an edge of the outer case 212 to discharge the air moved from the air movement pipe 260 and the movement guide unit 270.

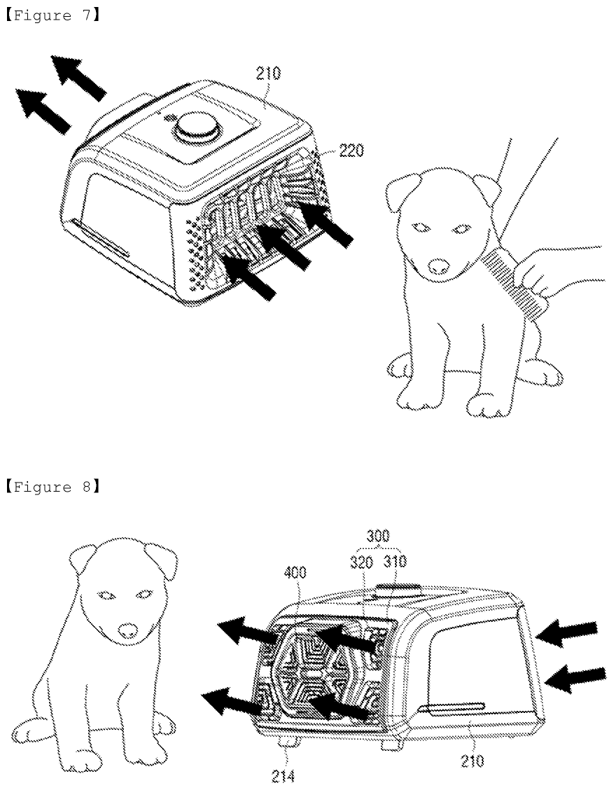

As an example, as illustrated in FIG. 8, a bathed pet may be located at the other side of the body part 210, and the hairs of the pet may be dried by a wind discharged to the discharge grill unit 320. In addition, hot air may be provided to the pet by using heat of an infrared lamp 420 by actuating an illumination unit 400 to be described below.

As illustrated in FIGS. 5 and 8, the air purifier 10 for pets that combines and separates a dust collector module according to an embodiment of the present invention includes the illumination unit 400.

The illumination unit 400 includes the infrared lamp 420 which is accommodated inside the other side of the dust collector module 200 and emits light.

To this end, the illumination unit 400 further includes an accommodation unit 410 and a transmission unit 430.

The accommodation unit 410 has a space extended toward the inside of the inner case 211 formed at the center of the cover body 310, and is connected to the board P to accommodate and actuate the infrared lamp 420.

The transmission unit 430 which is detached to open/close the center of the cover body 310 serves to transmit the light emitted by the infrared lamp 420 to the outside.

As a result, an effect in which dermatonosis, arthritis, and tympanitis of the pets may be prevented may be expected.

As illustrated in FIGS. 5 and 8, the air purifier 10 for pets that combines and separates a dust collector module according to an embodiment of the present invention may include a 3-axis sensor unit 500 capable of sensing different functions according to coupling or separating the dust collector module 200 to or from the air purifying module 100 inside the outer case 212.

That is, the 3-axis sensor unit 500 which is provided to prevent a confusion of a consumer by various actuation modes is used in a predetermined mode by sensing the location and the direction of the body part 210.

As described above, the preferred embodiment of the present invention is described in the detailed description of the invention, but this is to exemplarily describe a most preferred embodiment of the present invention, but does not limit the present invention. Further, it is apparent to all those skilled in the technical field to which the present invention pertains that various modifications and imitations can be made within the range without departing from the scope of the technical idea of the present invention.

Therefore, the scope of the present invention is not limited to the above-described embodiments, but may be implemented in various forms of embodiments within the scope of the appended claims. In addition, all ranges that can be modified without departing from the gist of the present invention claimed in the claims by those skilled in the art to which the invention pertains are considered to be within the scope of the claims of the present invention.

### DESCRIPTION OF REFERENCE SIGNS

10: Air purifier for pets that combines and separates the dust collector module
100: Air purifying module
110: Base body part
120: Suction port
130: First short edge
140: Second short edge
150: Light emitting unit
200: Dust collector module
210: Body part
211: Inner case
212: Outer case
213: Guide protrusion
220: Suction grill unit
221: Suction grill
222: Guide unit
223: Air movement unit
233: Heat discharge pipe
224: Communication hole
225: Introduction hole
226: Discharge hole
230: Suction fan unit
231: Motor fan shaft
232: Motor accommodation unit
240: Dust collection filter unit
250: Air rotation unit
251: Curve type partition
252: Introduction pipe
253: Discharge hole
260: Air movement pipe
260a: Air discharge hole
261: Sub air movement pipe
270: Movement guide unit
300: Cover unit
310: Cover body
320: Discharge grill unit
400: Illumination unit
410: Accommodation unit
420: Infrared lamp
430: Transmission unit
500: 3-axis sensor unit

1. An air purifier for pets that combines and separates a dust collector module, comprising:
an air purifying module that sucks in and purifies surrounding air, and discharges the air to the outside; and
a dust collector module in which one side is seated on, and coupled to or separated from an upper portion of the air purifying module to suck in at least one of air and hairs of a pet through one side.

2. The air purifier for pets that combines and separates a dust collector module of claim 1, wherein the air purifying module further comprises a base body part that has one or more suction ports at a lower portion, and one or more different types of filters therein.

3. The air purifier for pets that combines and separates a dust collector module of claim 1, wherein the dust collector module further comprises:
a body part having an inner case into which air discharged from the air purifying module is introduced and an outer case which surrounds a front surface, and a rear surface of the inner case and discharges the air moved through the inner case to the outside;
a suction grill unit coupled to one side of the outer case, and formed by a suction grill in which one surface has an inclination surface which is convex toward the inner case; and
a suction fan unit having a motor fan at one side of the inner case.

4. The air purifier for pets that combines and separates a dust collector module of claim 3, wherein the suction grill unit further comprises a guide unit that has each wall body on the inclination surface of the suction grill to guide the air.

5. The air purifier for pets that combines and separates a dust collector module of claim 3, wherein the suction grill unit further comprises an air movement unit, which is formed by a case coupled to be in communication with the suction fan unit and has a plurality of wall body protrusions arranged on one or more outer surfaces of the case.

6. The air purifier for pets that combines and separates a dust collector module of claim 3, wherein the dust collector module further comprises a dust collection filter unit, which is disposed between the suction grill and the air movement unit and collects the hairs of the pet introduced into the suction grill unit when locating the pet at one side of the inner case.

7. The air purifier for pets that combines and separates a dust collector module of claim 3, wherein the dust collector module further comprises an air rotation unit that rotates the air introduced into the inner case by arranging curve type partitions radially around the motor fan.

8. The air purifier for pets that combines and separates a dust collector module of claim 7, wherein the dust collector module further comprises an air movement pipe that surrounds the suction fan unit and extends toward the other side of the inner case, and moves the air discharged from the air rotation unit to the other side of the outer case.

9. The air purifier for pets that combines and separates a dust collector module of claim 8, wherein the dust collector module has a movement guide unit, which is arranged in plural one at least one side of a front surface and a rear surface of the inner case and moves the air discharged from the suction grill unit to the other side of the outer case.

10. The air purifier for pets that combines and separates a dust collector module of claim 9, wherein the dust collector module collects the air discharged from the air movement pipe and the air moved from the movement guide unit into the other side of the outer case to generate a pressure difference of the air.

11. The air purifier for pets that combines and separates a dust collector module of claim 9, comprising:
a cover unit having a cover body that opens/closes the other side of the dust collector module and at least one discharge grill unit on each of both sides of one surface of the cover body.

12. The air purifier for pets that combines and separates a dust collector module of claim 1, comprising:
an illumination unit including an infrared lamp that is accommodated inside the other side of the dust collector module and emits light.

13. The air purifier for pets that combines and separates a dust collector module of claim 3, wherein a 3-axis sensor unit capable of sensing different functions according to coupling or separating the dust collector module to or from the air purifying module is provided inside the outer case.
